(19) United States
(12) Patent Application Publication
(10) Pub. No.: US 2009/0089759 A1
(43) Pub. Date: Apr. 2, 2009

(54) System and Method for Providing Symbolic Execution Engine for Validating Web Applications

(75) Inventors: Sreeranga P. Rajan, Sunnyvale, CA (US); Oksana I. Tkachuk, Palo Alto, CA (US); Indradeep Ghosh, San Jose, CA (US); Mukul R. Prasad, San Jose, CA (US); Daryl R. Shannon, Houston, TX (US)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 11/866,043

(22) Filed: Oct. 2, 2007

(51) Int. Cl. G06F 9/44

(52) U.S. Cl. 717/126

(57) ABSTRACT

In accordance with a particular embodiment of the present invention, a method is offered that includes generating a symbolic string manipulation class library for one or more web applications. The manipulations are generalized into a string manipulation symbolic algebra. The method also includes performing symbolic execution for one or more web applications. Typically, a Java model checker is augmented to check for certain types of requirements or properties in performing the symbolic execution. If an error scenario exists, a solution to a set of symbolic constraints is obtained, and the solution is mapped back to a source code to obtain an error trace and a test case. In still other specific embodiments, requirements or properties are encoded through templates and checked using public domain decision procedures. The properties or requirements can relate to security validation. The symbolic execution can be customized and tuned for Java-based web applications.

### TECHNICAL FIELD OF THE INVENTION

This invention relates generally to the field of web applications and, more specifically, to a system and a method for providing a symbolic execution engine for validating the functionality of web applications.

### BACKGROUND OF THE INVENTION

Typically a software application is validated through testing where a series of regression tests are run either manually or automatically after each modification of the software. Such testing techniques usually give poor functional coverage of the application under test and, further, may be time consuming. To address these issues, formal verification techniques have emerged as an alternative technology to validate software systems. Such verification tools try to mathematically prove the satisfiability of a specific requirement on a software application or obtain a counterexample in the form of a test case that breaks the requirement—thus, pointing to a bug.

A formal verification system used in software validation typically uses a state-based model checker as its internal proof engine. The checker requires non-deterministic user inputs in the drivers that feed the application being checked. Such model checkers cannot reason on a complete input space. For example, in the case of a complete range of integers, strings, etc., it can only evaluate the possible scenarios that are specified in the drivers.

Symbolic execution is a different type of stateless model checking that treats all inputs to a program as symbols and creates complex equations by executing all possible paths in the program. These equations are then solved through a solver generally [called a decision procedure] to obtain error scenarios, if any. Thus far, symbolic execution has been only successful in handling primitive types like integers, floats, and Booleans in Java programs that are used to create most web applications. However, in the case of web applications, most of the inputs and primitive types are strings. Hence, it is necessary to model strings in the symbolic execution algebra. Also, it may be necessary to symbolically model frequently used data structures in web applications like lists, maps, sets, etc. for performance reasons.

Therefore, the ability to solve verification problems in web applications creates an interesting challenge. As with all such processing operations, of critical importance are issues relating to speed, accuracy, and automation.

### SUMMARY OF THE INVENTION

The present invention provides a method and a system for providing a symbolic execution engine for web applications that substantially eliminates or reduces at least some of the disadvantages and problems associated with previous methods and systems.

In accordance with a particular embodiment of the present invention, a method is offered that includes generating symbolic string manipulations for one or more web applications. The manipulations are generalized into a string manipulation symbolic algebra. The method also includes performing an integrated symbolic execution on other primitive data types like integers or Boolean values present in web applications. Typically, a Java model checker is augmented to check for certain types of properties while performing the symbolic execution. If an error scenario exists, a solution to a set of symbolic constraints is obtained, and the solution is mapped back to the source code to obtain an error trace.

In specific embodiments, a set of properties are identified that can be checked by symbolic execution type model checking, whereby properties are encoded through templates and checked using third party off-the-shelf decision procedures. The properties being checked can relate to security validation. Also, the symbolic execution can be customized and tuned for different types of Java-based web applications.

Technical advantages of particular embodiments of the present invention include: 1) exhaustive checking over input domain and feasible program execution paths; 2) creating user inputs in drivers becomes unnecessary; 3) unexpected errors/behaviors can be uncovered; 4) and automatic test data generation is available to uncover bugs if present.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a simplified block diagram illustrating an example model checker and the steps related to symbolic execution based model checking in accordance with one embodiment of the present invention;

FIG. 2 shows the architectural block diagram of the symbolic execution engine in one embodiment of the present invention;

FIG. 3 is simplified diagram illustrating the methodology for a combination of strings and other variables within the symbolic execution engine in one embodiment of the present invention;

FIG. 4 is a simplified block diagram illustrating an example application scenario addressing symbolic execution in security validation; and

FIG. 5 is a simplified block diagram illustrating an example symbolic execution methodology in accordance with one embodiment of the present invention.

### DETAILED DESCRIPTION OF THE INVENTION

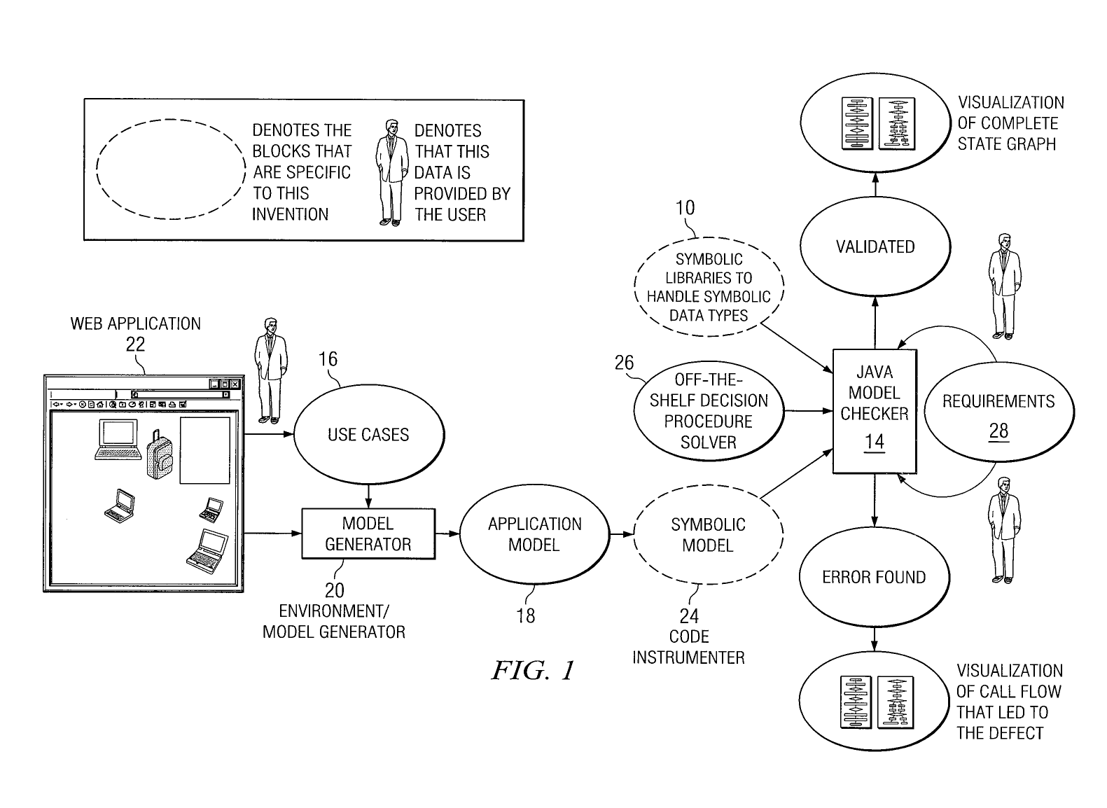

FIG. 1 is a simplified block diagram illustrating an example model checker and symbolic execution system library 10 related to one embodiment of the present invention. And a code instrumenter is provided to modify the application code to create a symbolic model 24 that facilitates symbolic execution. FIG. 1 includes a Java model checker 14, a set of use cases 16, an application 22, a model generator 20, an application model 18, a requirement/property specification tool 28 (abbreviated as ‘Requirements’ in FIG. 1, and a decision procedure solver 26 that can be off-the-shelf and that is used as a solver.

In accordance with the teachings of example embodiments of the present invention, the architecture presented herein creates a new symbolic execution engine that is tuned to web applications. Off-the-shelf components (e.g., Java model checker 14 and decision procedure solver 26), can be used to check for certain types of requirements/properties, which were not previously possible to identify.

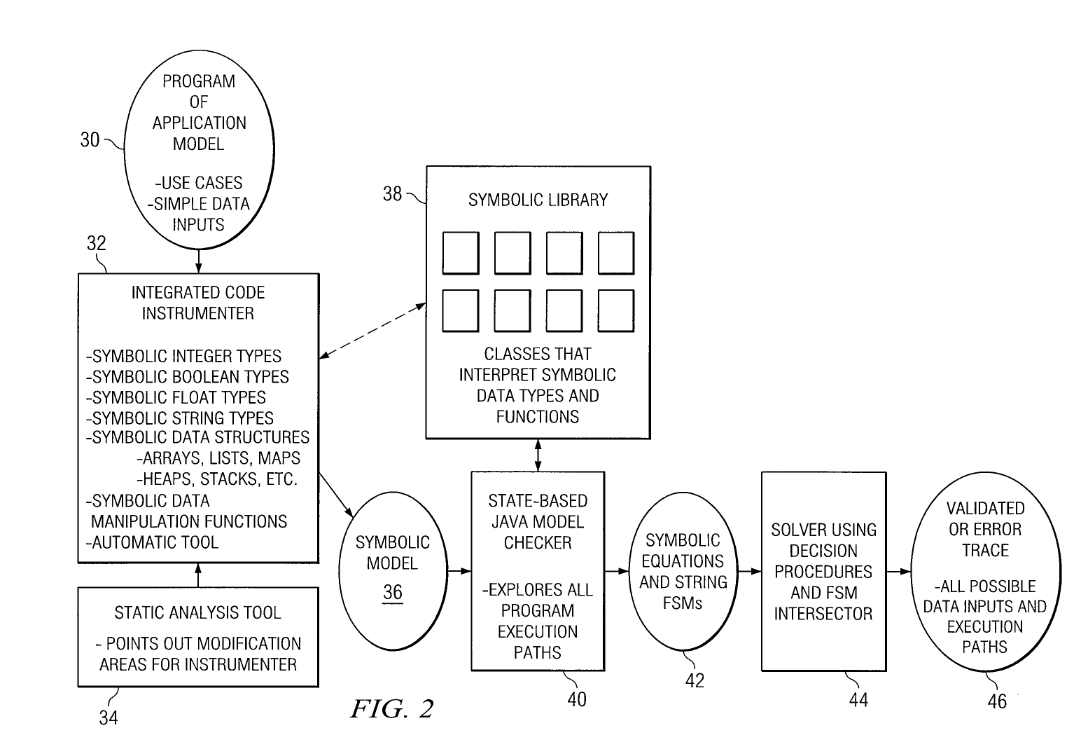

FIG. 2 is a top-level block diagram that illustrates the overall architecture of the symbolic execution engine. The system takes as input a program of an application model 30 that is created using a simple driver consisting of user specified use cases and simple data inputs. This model can be created through the process of environment generation. This application model is modified by an automatic, integrated code instrumenter 32 that modifies the model to take into account some symbolic data types that are specified in the driver. The instrumenter cannot only handle primitive data types like integers or Boolean values, but also strings, which are important in the Web applications domain. The instrumentation phase takes the help of a static analysis module 34. This module performs an approximate relevancy analysis on the application model to point out the exact sections of the code where the symbolic values in the driver can flow into. Only these sections of the application model are instrumented, thus, keeping the code modifications to a minimum.

As a result the symbolic execution of this instrumented code can have better performance and need less computing resources. The instrumentation phase creates a symbolic model 36 of the web application. It should be appreciated that different web applications can be studied to compile a series of possible symbolic manipulation functions on primitive data types. In this embodiment of the invention, string manipulations functions such as concatenation, truncation, upper case/lower case, etc., are generalized into a string manipulation symbolic algebra. Common data structures used in web applications such as lists, maps, arrays, etc. have also been symbolically modeled. These symbolic data manipulation functions are stored in a symbolic class library 38.

At this point, a traditional state-based Java model checker 40 is invoked to do the symbolic execution on symbolic model 36 where the instrumented functions are interpreted using symbolic library 36.

The result is a series of complex equations that model the non-string symbolic data and a series of finite-state machines (FSMs) that model the symbolic string data, as shown as a symbolic equations and string FSMs component 42. This is fed into an off-the-shelf decision procedure that solves the non-string equations and an FSM intersector (shown as component 44), which intersects the sets of symbolic strings with an FSM representing error strings at a particular point in the application program. If the solution of the decision procedure or the FSM intersection is empty, then a requirement is validated. If not, an error scenario is generated that is mapped back to the application code to generate a test case that uncovers a bug. This is shown in validated or error trace component 46. A set of properties/requirements have been identified in web applications that can only be checked by this type of symbolic execution based model checking. There are many such examples in security based properties that need exhaustive checking for complete confidence in the robustness of the web application.

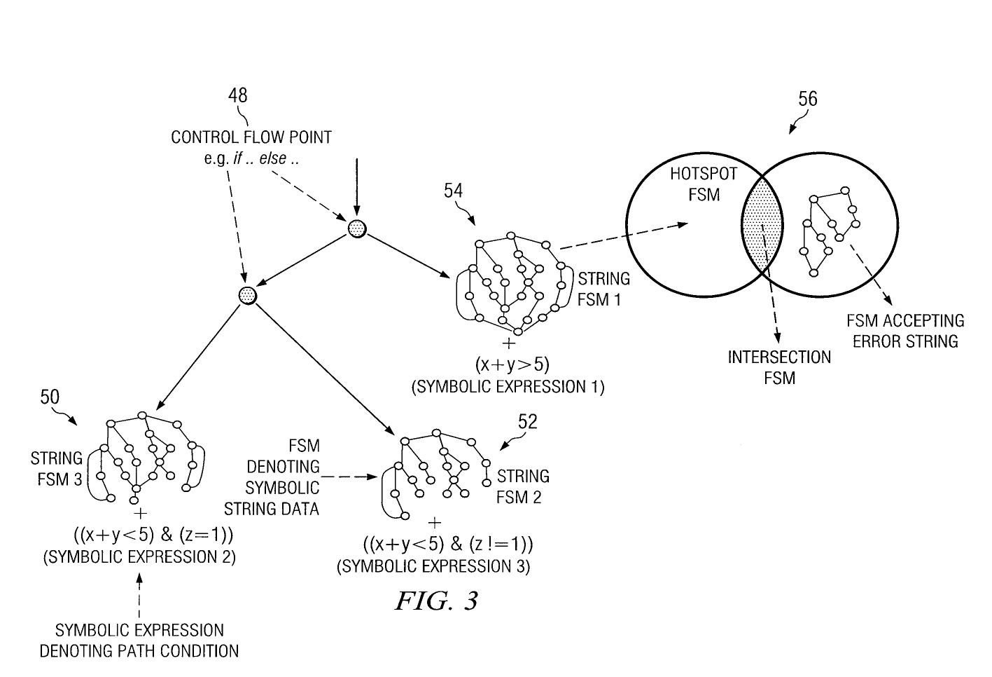

FIG. 3 illustrates the symbolic execution based model checking methodology in greater detail. The state based model checker exhaustively executes the symbolic model along all feasible paths in the program model. At every control point 48 in the program (e.g. an “if” statement), the execution branches off into two different directions. Along each path, a non-string symbolic equation is maintained, as well as a string FSM representing the possible set of strings at that program point. This is illustrated in items 50 and 52.

At a program hotspot 54, where a requirement is to be checked, the string FSM is intersected with an FSM representing the set of error strings that should not occur at that point. This set of strings is obtained from a user requirement and is shown in a component 56. In addition, the symbolic equation that encodes the program path that leads to the hotspot is solved with an off-the-shelf decision procedure solver. If the decision procedure solution is empty, then it signifies an impossible path or false path in the program. Alternately, if the intersection FSM is empty, then error strings are not possible at the hotspot. In either case the requirement is validated. However, if the decision procedure returns a solution (signifying a true path) and the intersection FSM is non-empty, then error strings are possible at the hotspot, and a bug is found. This solution is mapped back to the application program and percolated all the way up to the driver inputs to create an error trace and a test case that catches the bug. This test case generation is fully automated thereby reducing manual verification time. Moreover, such a test case may be missed if test cases are manually generated, thus, illustrating the usefulness of this technique.

Recall that the formal verification engine used in the software validation framework is a state-based model checker. The checker requires non-deterministic user inputs in the drivers. These model checkers cannot reason on a complete input space, for example, in a case of the whole range of integers, strings, etc., but can evaluate only the possible scenarios that are specified in the drivers.

In a case of symbolic execution, the model checking is stateless and it treats all inputs to a program as symbols, thereby, covering the complete input space. Symbolic execution has been only successful in handling primitive data (like integers and Booleans in a Java program). However, in the case of web applications, most of the inputs and primitive types are strings. Hence, it is necessary to model strings in the symbolic execution algebra.

However, the decision procedure used as a solver at the backend of this method is both CPU-time and memory intensive. Thus, it is necessary to symbolically model frequently used data structures in web applications like maps, sets, etc. for better performance of the decision procedure solver. Also, the amount of code instrumentation needed to create the symbolic model is kept to a minimum by using static analysis techniques (like relevancy analysis). This helps in reducing the size of the symbolic equations that need to be solved and, further, keeps the decision procedure complexity manageable.

The resultant architecture of the present invention offers a methodology that eliminates the need to create user inputs in drivers. Additionally, unexpected errors/behaviors can be uncovered. Also, with use of the present invention, manual test case generation time is reduced by automatically generating interesting test cases based on user requirement. Finally, the methodology has the potential to actually validate requirements based on exhaustive program path and input coverage. This is not possible using traditional testing methods but can be of critical importance in cases like security validation.

Note that deficiencies in formal validation techniques for software include: 1) state-based formal model checkers require input data in drivers; 2) an inability to handle all types of properties that span across the whole integer range, string range, etc.; and 3) automatic checking is limited to non-deterministic input choices provided in drivers.

Suppose there is a requirement that asks: Is it possible to have an integer in the input space that causes the system to break? In state-based model checking, it is not always possible to get that integer. To get around this issue, designers typically select a specific or a random integer to test for many scenarios. However, the exact integer that would cause a break condition would not necessarily be identified. A similar application involves strings in an input space (e.g., a login or a password where a malicious string is provided that orders the application to break). Again, the result is that, in these state-based scenarios, a designer does not know which string will break the application, so many have to be attempted.

Additionally, current symbolic execution engines are restrictive, for example: 1) algebra developed for integers, reals, and Booleans, but not for strings; 2) strings are the primary input values in web applications; and 3) certain data structures frequently used in web applications need to be modeled [e.g., hash-map, set, etc.]. Symbolic execution is able uncover error scenarios. Thus, the present invention aims to provide a symbolic execution engine that is customized and that is tuned for web applications.

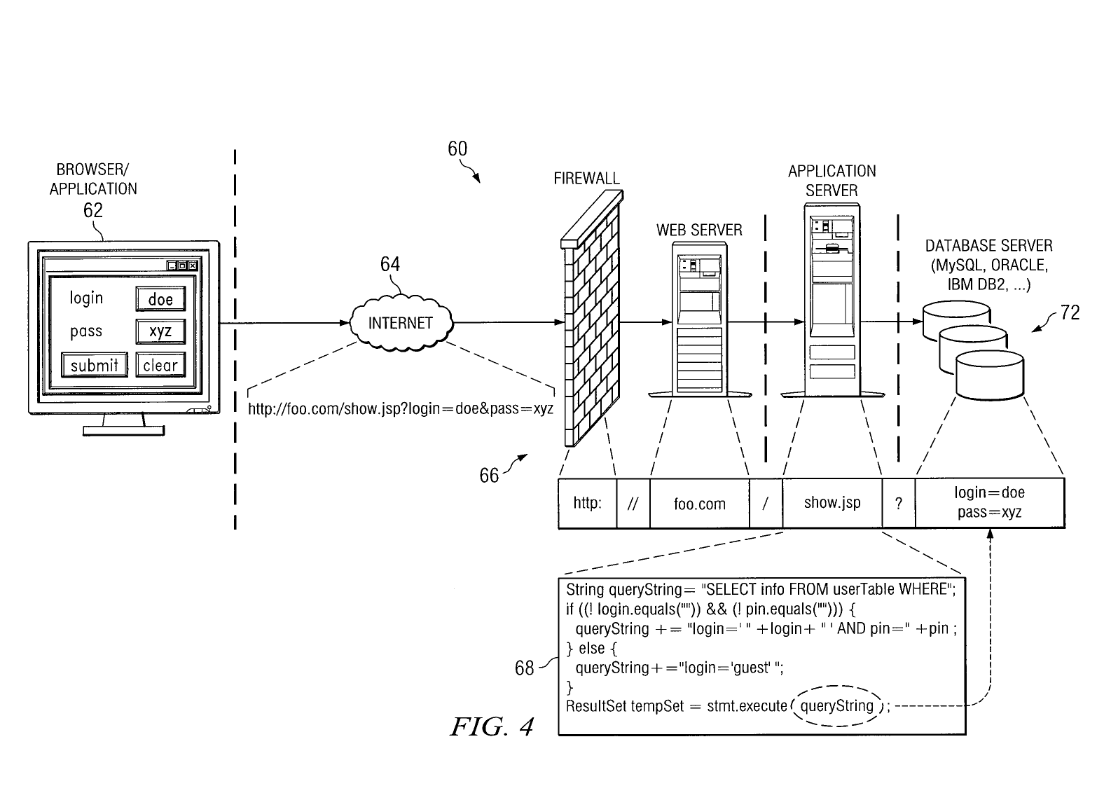

FIG. 4 is a simplified block diagram illustrating an example application scenario addressing symbolic execution in security validation. FIG. 4 includes a vulnerable web application 60, a browser application 62, an Internet model 64, and a back-end component 66 that is connected to Internet 64. Within back-end component 66 is a firewall, a web server, an application server, and a database 72, which could be any suitable database object (such as MySQL, Oracle, IBM DB2, etc.).

Illustrated in FIG. 4 are some of the rough steps for achieving the teachings of the present invention. This represents a simple example in which there is a generic login [doe] and password [xyz].

FIG. 4 also includes a code segment 68, which is executed in this application as:

```
String queryString = “SELECT info FROM userTable WHERE ”;
  if ((! login.equals(“”)) && (!pin.equals(“”)))  {
    queryString += “login=‘“ + login + ”’ AND pin=” + pin ;
        } else {
          queryString+=“login=‘guest’”;
      }
      ResultSet tempSet = stmt.execute(queryString);
```

In a normal usage configuration, the user submits a generic login “doe” and a pin “123.” [SELECT info FROM users WHERE login=doe AND pin=123.] In the case of malicious usage, an attacker submits ‘; SHUTDOWN;—’ and pin of ‘0’. [SELECT info FROM users WHERE login=; SHUTDOWN;— AND pin=0.] The response in this scenario is that the database shuts down. This illustrates a piggy-back, stored procedure attack. This is a type of security attack on the web application database by only using the web browser and is known as an SQL injection attack. Such malicious strings can be detected and, further, restricted from reaching the database by using the present invention. This is further detailed and discussed below.

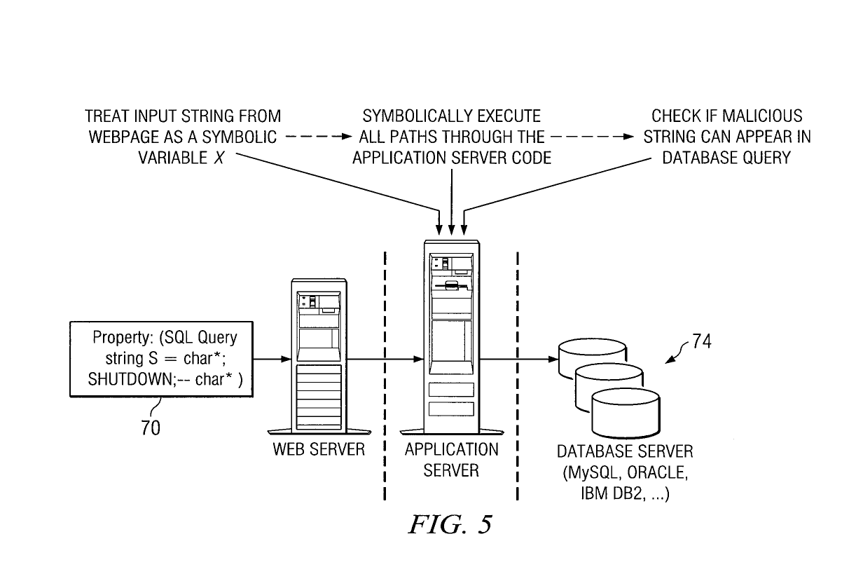

FIG. 5 is a simplified block diagram illustrating an example symbolic execution methodology in accordance with one embodiment of the present invention. FIG. 5 includes an error property component 70 and a component 74 that interfaces with that property component 70. In this example, component 74 includes a web server, an application server, and a database server.

As is demonstrated in FIG. 5, a symbolic string variable (X) is used to denote the login input. The error string is set as a query string, with some set of characters followed by ‘;SHUTDOWN;—’ embedded in an arbitrary string, and then followed by additional characters. The symbolic execution operation is performed as specified in FIGS. 4 and 5 for the application server code in order to generate all possible strings, which could be possibly input into the database as a query at a particular hotspot in the program. Then, the FSM denoting the set of strings at the hotspot is intersected with the target malicious string FSM to identify a non-empty set if any. If it is so, then a way has been found to communicate a malicious string to the database. Hence, this type of symbolic execution of strings is an effective method to look for these types of security attacks.

Thus, a symbolic execution methodology and formal model checking techniques have been used to find security holes. There are several steps in the interaction of FIG. 5, which are formalized here. First, treat the input string from a webpage as a symbolic variable X. Second, symbolically execute all paths through the application server code and create symbolic path equations and FSMs representing sets of possible strings at the database query hotspot. Third, check if the malicious string, as specified in a requirement/property, can appear in the database query by intersecting the two FSMs and solving the path conditions through decision procedure solvers.

In this scenario, a person can check not only expected inputs, but also unexpected ones. This can be accomplished using a sophisticated symbolic string manipulation library. [e.g., “declare @a char(20) select @a=0x73687574646f776e exec(@a)”]. This represents HEX for ‘SHUTDOWN’. The symbolic string manipulation libraries can automatically check for this variant of the malicious string.

In terms of advantages, the custom symbolic execution engine offers exhaustive checking over the input domain and over all feasible paths in the application program. There is no need for user inputs in drivers. In this case, unexpected behaviors/errors can be found. Moreover, the system is coupled with a GUI-based, intuitive user interface for specifying requirements/properties. The architecture can be customized and tuned for Java-based web applications. Thus, such an optimized architecture offers a symbolic execution tuned to web applications, which includes string manipulation algebra and applications for security validation. Such types of property checks that need to reason on the complete input space are not possible other than through this technology.

It is critical to note that the components illustrated in FIGS. 1, 2, 3, 4, and 5 may be implemented as digital circuits, analog circuits, software, or any suitable combination of these elements. In addition, any of these illustrated components may include software and/or an algorithm to effectuate their features and/or applications as described herein. The software can execute code such that the functions outlined herein can be performed. Alternatively, such operations and techniques may be achieved by any suitable hardware, component, device, application specific integrated circuit (ASIC), additional software, field programmable gate array (FPGA), processor, erasable programmable ROM (EPROM), electrically erasable programmable ROM (EEPROM), or any other suitable object that is operable to facilitate such operations. Considerable flexibility is provided by the structure of these architectures in the context of this arrangement. Thus, it can be easily appreciated that such functions could be provided external to the outlined environment. In such cases, such a functionality could be readily embodied in a separate component, device, or module.

While the present invention has been described in detail with specific components being identified, various changes and modifications may be suggested to one skilled in the art and, further, it is intended that the present invention encompass any such changes and modifications as clearly falling within the scope of the appended claims.

Note also that, with respect to specific process flows disclosed, any steps discussed within the flows may be modified, augmented, or omitted without departing from the scope of the invention. Additionally, steps may be performed in any suitable order, or concurrently, without departing from the scope of the invention.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A method, comprising:
generating a set of symbolic string manipulation library classes for one or more web applications, wherein the manipulations are generalized into a string manipulation symbolic algebra; and
performing symbolic execution based model checking to verify requirements or properties for one or more of the web applications.

2. The method of claim 1, wherein a state-based Java model checker is augmented to check for certain types of requirements or properties by performing the symbolic execution using the string manipulation symbolic algebra.

3. The method of claim 1, wherein different web applications are evaluated to compile a series of possible string manipulations, which can include concatenation, truncation, and upper case/lower case transformations.

4. The method of claim 1, wherein if an error scenario exists, a solution to a set of symbolic constraints is obtained, and wherein the solution is mapped back to the application source code to obtain an error trace and a concrete test case to uncover the error.

5. The method of claim 1, wherein if an error scenario does not exist the requirement is stated to be proved.

6. The method of claim 1, wherein the initial application model is transformed through automatic code instrumentation to create a symbolic model including symbolic strings, symbolic integers, floats, and Boolean values.

7. The method of claim 6, wherein the instrumentation is restricted by static analysis and relevancy analysis techniques.

8. The method of claim 6, wherein the instrumentation creates symbolic models of popular data structures including heaps, stacks, arrays or lists.

9. The method of claim 1, wherein program path conditions are represented by symbolic equations on traditional data types and combined with symbolic string data represented by finite state machines in a state-based model checker.

10. The method of claim 1, wherein a requirement or property, which is based on input strings, is checked by intersecting a finite state machine representing symbolic strings at a program point with a set of finite state machines representing symbolic strings that are not permissible according to the requirement.

11. The method of claim 1, wherein a set of requirements or properties are identified that can be checked by the symbolic execution based model checking.

12. The method of claim 1, wherein requirements or properties are encoded through templates and checked using public domain decision procedures.

13. The method of claim 1, wherein symbolic analysis on an application program is performed using algebra and models.

14. The method of claim 1, wherein the requirements or properties on web applications can relate to security validation.

15. The method of claim 1, wherein the symbolic execution engine is customized and tuned for Java-based web applications.

16. Logic embedded in a computer medium and operable to:
generating a set of symbolic string manipulation library classes for one or more web applications, wherein the manipulations are generalized into a string manipulation symbolic algebra; and
performing symbolic execution based model checking to verify requirements or properties for one or more of the web applications.

17. The logic of claim 16, wherein a state-based Java model checker is augmented to check for certain types of requirements or properties by performing the symbolic execution using the string manipulation symbolic algebra.

18. The logic of claim 16, wherein different web applications are evaluated to compile a series of possible string manipulations, which can include concatenation, truncation, and upper case/lower case transformations.

19. The logic of claim 16, wherein if an error scenario exists, a solution to a set of symbolic constraints is obtained, and wherein the solution is mapped back to the application source code to obtain an error trace and a concrete test case to uncover the error.

20. The logic of claim 16, wherein if an error scenario does not exist the requirement is stated to be proved.

21. The logic of claim 16, wherein the initial application model is transformed through automatic code instrumentation to create a symbolic model including symbolic strings, symbolic integers, floats, and Boolean values.

22. The logic of claim 21, wherein the instrumentation is restricted by static analysis and relevancy analysis techniques.

23. The logic of claim 21, wherein the instrumentation creates symbolic models of popular data structures including heaps, stacks, arrays or lists.

24. The logic of claim 16, wherein program path conditions are represented by symbolic equations on traditional data types and combined with symbolic string data represented by finite state machines in a state-based model checker.

25. The logic of claim 16, wherein a requirement or property, which is based on input strings, is checked by intersecting a finite state machine representing symbolic strings at a program point with a set of finite state machines representing symbolic strings that are not permissible according to the requirement.

26. The logic of claim 16, wherein a set of requirements or properties are identified that can be checked by the symbolic execution based model checking.

27. The logic of claim 16, wherein requirements or properties are encoded through templates and checked using public domain decision procedures.

28. The logic of claim 16, wherein symbolic analysis on an application program is performed using algebra and models.

29. The logic of claim 16, wherein the requirements or properties on web applications can relate to security validation.

30. The logic of claim 16, wherein the symbolic execution engine is customized and tuned for Java-based web applications.

31. A system, comprising:
a symbolic execution based Java model checker, generating a set of symbolic string manipulation library classes for one or more web applications, wherein the manipulations are generalized into a string manipulation symbolic algebra; and
performing symbolic execution based model checking to verify requirements or properties for one or more of the web applications.

32. The system of claim 31, wherein a state-based Java model checker is augmented to check for certain types of requirements or properties by performing the symbolic execution using the string manipulation symbolic algebra.

33. The system of claim 31, wherein different web applications are evaluated to compile a series of possible string manipulations, which can include concatenation, truncation, and upper case/lower case transformations.

34. The system of claim 31, wherein if an error scenario exists, a solution to a set of symbolic constraints is obtained, and wherein the solution is mapped back to the application source code to obtain an error trace and a concrete test case to uncover the error.

35. The system of claim 31, wherein if an error scenario does not exist the requirement is stated to be proved.

36. The system of claim 31, wherein the initial application model is transformed through automatic code instrumentation to create a symbolic model including symbolic strings, symbolic integers, floats, and Boolean values.

37. The system of claim 36, wherein the instrumentation is restricted by static analysis and relevancy analysis techniques.

38. The system of claim 36, wherein the instrumentation creates symbolic models of popular data structures including heaps, stacks, arrays or lists.

39. The system of claim 31, wherein program path conditions are represented by symbolic equations on traditional data types and combined with symbolic string data represented by finite state machines in a state-based model checker.

40. The system of claim 31, wherein a requirement or property, which is based on input strings, is checked by intersecting a finite state machine representing symbolic strings at a program point with a set of finite state machines representing symbolic strings that are not permissible according to the requirement.

41. The system of claim 31, wherein a set of requirements or properties are identified that can be checked by the symbolic execution based model checking.

42. The system of claim 31, wherein requirements or properties are encoded through templates and checked using public domain decision procedures.

43. The system of claim 31, wherein symbolic analysis on an application program is performed using algebra and models.

44. The system of claim 31, wherein the requirements or properties on web applications can relate to security validation.

45. The system of claim 31, wherein the symbolic execution engine is customized and tuned for Java-based web applications.
